(19) United States
(12) Patent Application Publication
(10) Pub. No.: US 2022/0095613 A1
(43) Pub. Date: Mar. 31, 2022

(54) PROPYLENE OXIDE CAPPED LIQUID POLYMERIC SURFACTANTS FOR AGRICULTURAL COMPOSITIONS AND AGRICULTURAL COMPOSITIONS INCLUDING PESTICIDE

(71) Applicant: Dow Global Technologies LLC, Midland, MI (US)

(72) Inventors: Diana Marcela Vasquez Gutierrez, Houston, TX (US); Yuri Alencar Marques, Rosharon, TX (US); Wanglin Yu, Pearland, TX (US)

(73) Assignee: Dow Global Technologies LLC, Midland, MI (US)

(21) Appl. No.: 17/439,854

(22) PCT Filed: Mar. 18, 2020
(86) PCT No.: PCT/US2020/023317

§ 371 Date: Sep. 16, 2021

Related U.S. Application Data
(60) Provisional application No. 62/821,655, filed on Mar. 21, 2019.

(51) Int. Cl. A01N 25/30

(52) U.S. Cl. CPC A01N 25/30

(57) ABSTRACT

Propylene capped liquid polymeric surfactants for agricultural compositions and agricultural compositions including pesticide are provided. For instance, agricultural compositions can include: (a) an agricultural oil; and (b) an agricultural oil-compatible, propylene oxide (PO)-capped liquid polymeric surfactant having the following structure: (I) wherein m is an integer from about 3 to about 7, n is an integer from about 5 to about 20, and o is an integer from about 3 to about 30, and R is a linear or branched C4-C18 alkyl chain.

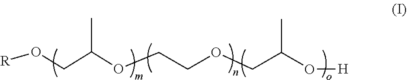

### FIELD OF DISCLOSURE

The present disclosure relates generally to agricultural compositions and agricultural compositions including pesticide. More specifically, but without limitation, the disclosure relates to agricultural compositions and agricultural compositions including pesticide comprising an agricultural oil-compatible, propylene oxide (PO)-capped liquid polymeric surfactant.

### BACKGROUND

Various adjuvants can be employed in compositions including pesticide, for instance, to enhance the performance of active ingredients such as herbicides, insecticides and/or fungicides. Examples of adjuvants include wetting agents, crop oil concentrates (COCs), spreaders, stickers, buffering agents, foaming and anti-foaming agents, dispersing agents and drift control agents.

COCs are a commonly employed adjuvant. COCs can be included in agricultural formulations to increase the efficacy of active ingredient in the agricultural formulations. For instance, COCs can promote movement of the active ingredient, decrease surface tension of a spray solution, and/or improve wetting.

COCs can be a combination of an agricultural oil such as petroleum/vegetable-derived oils and a surfactant. Examples of surfactants that may be employed in COCs include nonionic surfactants, such as alkyl phenol ethoxylates (APEOs), alcohol ethoxylates, castor oil ethoxylates, sorbitan esters and their reaction products with ethylene oxide (EO), and block copolymers of EO and propylene oxide (PO). The surfactant can permit the agricultural oil to be emulsified responsive to the addition of water to the COC formulation and thereby form oil/water emulsions (O/W). In addition, the surfactant may provide additional benefits such as decreasing a surface tension of a spray solution and/or improving wetting of a surface such as a leaf surface.

However, inclusion of a surfactants in COCs can lead to an undesired increase in foaming. Moreover, some surfactants may be insoluble in agricultural oils and/or may not permit emulsification of the agricultural compositions including water. Increased foaming, insolubility in agricultural oil, and/or lack of emulsification can result in difficulties in the delivery and/or a decrease in efficacy of an active ingredient such as a pesticide. As such, it may be desirable for a surfactant to exhibit oil solubility, low foam generation, and enhanced emulsibility.

Further, it may be desirable for a surfactant to be in a liquid state to improve processability/performance. However, not all surfactants are liquid. For instance, U.S. Pat. Nos. 3,955,401 and 4,317,940 each describe a PO-EO—PO triblock adducts that are semi-solid (slush to solid) at room temperature.

Further still, it may be desirable for a surfactant to be readily biodegradable. However, not all surfactants are readily biodegradable. U.S. Pat. No. 4,925,587 also discloses a diblock copolymer with a linear aliphatic hydrocarbon end. U.S. Pat. Nos. 3,955,401 and 4,317,940 each describe a PO-EO—PO triblock copolymers prepared with a linear initiator so to have a linear aliphatic hydrocarbon on a PO end of the copolymer. Notably, each of the surfactants in the above references (U.S. Pat. Nos. 4,925,587; 3,955,401 and 4,317,940) is initiated with a linear initiator to achieve a linear hydrocarbon group on the final surfactant. The reason a linear hydrocarbon group is perceived as being so important is because it has long been held that branching in a surfactant determinately affects the biodegradability of the surfactant. For example, U.S. Pat. Nos. 3,955,401 and 4,317,940 each teach that “the biodegradability of the product is detrimentally affected by branching.” Therefore, to achieve biodegradability, the surfactants are prepared using linear alcohols as initiators. The detrimental effect of branching in biodegradability is further affirmed in a study of ethoxylate polymers that concluded that polymers initiated with single or multiple-branched alcohols did not show a significant degradation while significant degradation was observed to ethoxylates with linear alcohols and iso-alcohol. (See, M. T. Muller, M. Siegfried and Urs Bauman; “Anaerobic Degradation and Toxicity of Alcohol Ethoxylates in Anaerobic Screening Test Systems”, presented at 4th World Surfactants Congress, 1996). None of the references describe a liquid surfactant that exhibits oil solubility, low foam generation, and enhanced emulsibility, and yet is readily biodegradable.

There is a clear market need for a liquid surfactant that exhibits oil solubility, low foam generation, and enhances emulsibility. There also is a clear market need for a liquid surfactant that exhibits oil solubility, low foam generation, and enhances emulsibility, and yet is readily biodegradable.

### SUMMARY

In various embodiments, the present disclosure includes an agricultural composition comprising:
(a) an agricultural oil; and
(b) an agricultural oil-compatible, propylene oxide (PO)-capped liquid polymeric surfactant having the following structure:

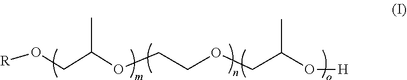

wherein m is an integer from about 3 to about 7, n is an integer from about 5 to about 20, and o is an integer from about 3 to about 30, and R is a linear or branched C4-C18 alkyl chain.

In various embodiments, the present disclosure includes an agricultural composition including pesticide comprising:
(a) an agricultural oil;
(b) an agricultural oil-compatible, PO-capped liquid polymeric surfactant having the following structure:

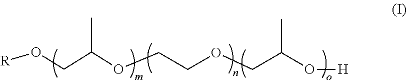

wherein m is an integer from about 3 to about 10, n is an integer from about 5 to about 20, and o is an integer from about 3 to about 30, and R is a linear or branched C4-C18 alkyl chain; and
(c) a pesticide.

As detailed herein, the agricultural oil-compatible, PO-capped liquid polymeric surfactant of this disclosure surprisingly provides improved oil solubility, low foam performance, and enhanced emulsibility. That is, advantages of the agricultural oil-compatible, PO-capped liquid polymeric surfactant of this disclosure over other surfactants, may include: (1) improved oil solubility; (2) improved (low) foam performance; (3) enhanced emulsibility; (4) being liquid and/or (5) being readily biodegradable.

### DETAILED DESCRIPTION

In various embodiments, the present disclosure includes agricultural compositions comprising (a) an agricultural oil and (b) an agricultural oil-compatible, PO-capped liquid polymeric surfactant having the following structure:

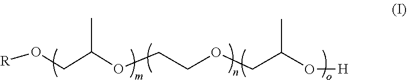

wherein m is an integer from about 3 to about 10, n is an integer from about 5 to about 20, and o is an integer from about 3 to about 30, and R is a linear or branched C4-C18 alkyl chain.

As used herein, being “propylene oxide (PO)-capped” refers to the presence of a propylene oxide constituent at the terminal block of a R—PO-EO—PO triblock copolymer, in contrast to other surfactants lacking a PO constituent or other approaches without PO at terminal block of a block copolymer such as in a R—PO-EO diblock copolymers having EO at the terminal block.

As used herein, the terms “a,” “an,” “the,” “at least one,” and “one or more” are used interchangeably. The terms “comprises” and “includes” and variations thereof do not have a limiting meaning where these terms appear in the description and claims. Thus, for example, “a” material can be interpreted to mean “one or more” materials, and a composition that “includes” or “comprises” a material can be interpreted to mean that the composition includes things in addition to the material.

The recitations of numerical ranges by endpoints include all numbers subsumed within that range, e.g., 1 to 5 includes 1, 1.5, 2, 2.75, 3, 3.80, 4, 5, etc.

By “particle size” herein is meant the number average particle diameter as measured, for example by light scattering techniques.

The term “polymer” as used herein includes oligomers.

The term “about” as used herein means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Unless stated to the contrary, implicit from the context, or customary in the art, all parts and percentages are based on weight.

The agricultural oils used in the agricultural compositions and agricultural compositions including pesticide of this invention are water-immiscible compounds suitable for agrochemical application, typically of high purity, and generally composed of a single aliphatic or aromatic chemical structure. They may be branched or linear in nature with typical carbon chain lengths of C₆ to C₂₆ or C₂₀ to C₂₆. They are characterized by low odor, low solvency for organic and organometallic compounds, low phytotoxicity to biological species, and low volatility. Commercial examples of agricultural oil include: Aromatic 200, Aromatic 150, methylated seed oil (MSO), Orchex 796, Orchex 692, Sunspray 7N, Sunspray 11N, Oleo Branco, Isopar M, Isopar V, 100 Neutral, and Exxsol D-130. Other oils such as mineral oil; crop oil such as, for example, vegetable oil, peanut oil, canola oil and cottonseed oil; or synthetic oil may be acceptable.

In various embodiments the agricultural oil-compatible, PO-capped liquid polymeric surfactant having the following structure:

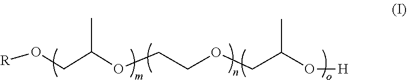

where m is an integer from about 0 to about 10, n is an integer from about 5 to about 20, and o is an integer from about 3 to about 30, and R is a linear or branched C4-C18 alkyl chain; or

where m is an integer from about 3 to about 7, n is an integer from about 5 to about 20, and o is an integer from about 3 to about 30, and R is a linear or branched C4-C18 alkyl chain; or

where m is an integer from about 3 to about 10, n is an integer from about 5 to about 20, and o is an integer from about 3 to about 30, and R is a branched C4-C18 alkyl chain, among other possibilities. That is, the values of m, n, and/or o can be varied as detailed herein.

For instance, in some embodiments m is an integer from about 0 to about 10. All individual values and subranges from about 0 to about 10 are included; for example, m can be from a lower limit of about 1, 2, 3, 4, or 5 to an upper limit of about 10, 9, 8, 7, 6, or 5. For instance, in some embodiments m can be an integer from about 3 to about 7, an integer from about 3 to about 6, or an integer from about 3 to about 5. In some embodiments m can be equal to about 5.

In some embodiments, n is an integer from about 5 to about 20. All individual values and subranges from about 5 to about 20 are included; for example, n can be from a lower limit of about 5, 6, 9, 10, or 11 to an upper limit of about 20, 15, 14, or 10. For instance, in some embodiments n can be an integer from about 3 to about 9, from about 6 to about 9, from about 9 to about 14, or an integer from about 9 to about 15. In some embodiments n can be equal to about 6 or 9 or equal to about 14.

In some embodiments o is an integer from about 3 to about 30. All individual values and subranges from about 3 to about 30 are included; for example, o can be from a lower limit of about 3, 5, 10 or 15 to an upper limit of about 30, 25, 20, 15, 14, or 10. For instance, in some embodiments o is an integer from about 5 to about 20, an integer from about 5 to about 30, an integer from about 5 to about 25, an integer from about 10 to about 25, or an integer from about 15 to about 25. In some embodiments o can be equal to about 5, about 10, about 15, about 20, or about 25.

In various embodiments R can be branched C4-C18 alkyl chain or a linear C4-C18 alkyl chain. That is, in some embodiments R is a branched C4-C18 alkyl chain. However, in some embodiments R can be a linear C4-C18 alkyl chain. In some embodiments R can be formed of a branched alkyl with each branch having a length of two carbons or more.

In various embodiments the agricultural compositions can have agricultural oil (a) present at least at least 60 percent, at least 70 percent or at least 80 percent by weight per volume of the agricultural composition. That is, the agricultural oil (a) can be present in an amount from about 60 percent to about 99 percent by weight per volume of the agricultural composition. Similarly, the agricultural oil can be from about 60 percent to about 99 percent, at least 60 percent, at least 70 percent or at least 80 percent by weight per volume of the agricultural compositions including pesticide as described herein.

In various embodiments the agricultural oil-compatible, PO-capped liquid polymeric surfactant (b) is from present in an amount from about 0.5 to 40.0 percent, from about 1.0 to about 20.0 percent, from about 10.0 to about 20.0 percent, or from about 15.0 to about 20.0 percent by weight per volume of the agricultural composition. That is, the agricultural oil-compatible, PO-capped liquid polymeric surfactant can be present in an amount from about 0.5 percent to about 40 percent by weight per volume of the agricultural composition. Similarly, the agricultural oil-compatible, PO-capped liquid polymeric surfactant can be from about 0.5 to 40.0 percent, 1.0 to about 20.0 percent, from about 10.0 to about 20.0 percent, or from about 15.0 to about 20.0 percent by weight per volume of the agricultural compositions including pesticide as described herein.

In various embodiments the agricultural composition can include a pesticide. The pesticide can be a liquid pesticide or a particulate pesticide, among other types of pesticides. For instance, the pesticide can be technical grade particulate pesticides (“technicals”) or formulated particulate pesticide compositions such as, for example, wettable powders and dispersible granules. The technical grade particulate pesticides range in active ingredient content from 80 to 98 percent by weight and are solid at room temperature. The wettable powders and dispersible granules range in active ingredient content from 45 percent by weight to 75 percent by weight and have typical compositions as follows: 45 to 75 percent by weight pesticide; 20 to 50 percent by weight carrier; 2 to 10 percent by weight dispersant; and from 2 to 10 percent by weight surfactant. The wettable powders and dispersible granules typically have been milled to an average particle size in the range of 2 to 10 microns.

The choice of pesticide is not particularly critical with respect to the quality of the agricultural compositions including pesticide. Examples of pesticides that may be employed herein include particulate agronomically effective fungicides, herbicides, and insecticides such as, for example, chlorinated nitrile, triazole, aralkyl triazole, triazole anilide, benzamide, alkyl benzamide, diphenyl ether, pyridine carboxylic acid, chloroaniline, organophosphate, phosphonic glycine salt, and mixtures thereof. Also included are mixtures of the pesticides with other organic or inorganic agronomically active ingredients, for example, Dithane+Indar, Dithane+chlorothalonil, Dithane+cymoxanil, and Dithane+copper hydroxide. Additional examples of pesticides can be found in U.S. Pat. No. 6,210,696. Mixtures of pesticides may be employed.

The agricultural composition including pesticide of this disclosure is a agricultural compositions including pesticide comprising:
(a) an agricultural oil;
(b) an agricultural oil-compatible, propylene oxide (PO)-capped liquid polymeric surfactant having the following structure:

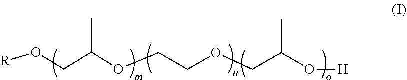

wherein m is an integer from about 3 to about 10, n is an integer from about 5 to about 20, and o is an integer from about 3 to about 30, and R is a branched C4-C18 alkyl chain; and
(c) a pesticide.

The agricultural compositions including pesticides of this disclosure are typically applied in the field as dilutions into oil or oil/water/surfactant carriers. The agricultural compositions and/or agricultural compositions including pesticide of the present disclosure may contain other formulated agronomic additives such as, for example, an antifoaming agent, a stabilizer, a fragrant, a sequestering agent, a neutralizing agent, a buffer, a corrosion inhibitor, a dye, a softener, an odorant, and an additional surfactant and/or surfactant adjuvant. Concentrated formulations may be diluted from 1 to 2000 fold at point of use depending on the intended agricultural application. Application may be made by ground or aerial spray equipment.

The effective amount of the agricultural compositions including pesticide of the present invention to be employed in a typical agricultural application often depends upon for example, the type of plants, the stage of growth of the plant, severity of environmental conditions, the weeds, insects or fungal pathogens to be controlled and application conditions. Typically, a plant in need of protection from weeds or insects, or disease pathogen control or elimination, is contacted with an amount of the agricultural compositions including pesticide diluted in a carrier such as water that will provide an amount from about 1 to about 40,000 ppm, preferably from about 10 to about 20,000 ppm of the active ingredient.

That is, in some embodiment the agricultural composition and/or the agricultural compositions including pesticide described herein can include water. Notably, the agricultural compositions/agricultural compositions including pesticide of the present disclosure, in addition to be liquid and oil soluble, also exhibit lower foaming and improved emulsion stability as compared to agricultural compositions without (b) [Applicant's agricultural oil-compatible, PO-capped liquid polymeric surfactant], as detailed below in the Working Examples.

### SPECIFIC EMBODIMENTS

Materials

2EH/5PO/9EO and 2EH/5PO/14EO are alcohol alkoxylated block copolymers obtainable as described below with the general structure R—(PO)ₘ-(EO)ₙ wherein R is a 2-ethylhexanol, m=5, and n=9 or 14, respectively.

TERGITOL™ XD is a butanol-PO/EO copolymer obtainable from Sigma-Aldrich.

DOWFAX™ 100N50 a butanol-PO/EO copolymer obtainable from The DOW Chemical Company.

Soybean oil is obtained from Duwest.

MSO is obtained from Stepan under the tradename STEPOSOL® ME.

### Working Examples 1-7 (WE 1-7) and Comparative Examples 1-4 (CE 1-4)

For CE 1-4, procured four different competitive surfactants from the sources as detailed above and performed testing as detailed herein. Specifically, CE 1 corresponds to the surfactant of the formula 2EH/5PO/9EO, CE 2 corresponds to the surfactant of the formula 2EH/5PO/14EO, CE 3 corresponds to the surfactant available under that tradename TERGITOL™ XD, and CE 4 corresponds to the surfactant available under that tradename DOWFAX™ 100N50.

For WE 1-7, prepared seven different surfactants of structure (I) as described in Table 1 using the following procedure in accordance with the procedure described in U.S. patent application number 2017/028,3742 A1 (the entire contents of which is hereby incorporated) as follows.

Charge 780.0 grams of 2-ethylhexanol and 10.81 grams of 85 percent potassium hydroxide pellets into a nine liter reactor that has been purged with nitrogen. Gradually apply vacuum to the reactor over two hours to achieve 100 millimeter mercury. Remove 15.8 grams of mixture from the reactor and measure for water content by Karl Fisher titration (411 parts per million by weight (ppm)). Pressurize and vent the reactor seven times with dry nitrogen to remove atmospheric oxygen and pressurize with nitrogen to 110 to 139 kiloPascals (kPa) at 25° C. Heat the contents of the reactor while agitating to 130° C. and then meter in 1660 grams propylene oxide over 4 hours. After completing the propylene oxide feed, agitate the reactor contents at 130° C. for an additional 2 hours and then cool to 60° C. Remove 142.9 grams of reactor contents. Heat the reactor contents to 130° C. and meter in 2070 grams of ethylene oxide into the reactor over 4 hours. After completing the ethylene oxide feed, agitate the reactor contents at 130° C. for 2 hours and then cool to 60° C. Remove 142.9 grams of the reactor contents and neutralize with acetic acid to achieve a pH of 4-8 (in 10 percent aqueous solution) to obtain the CE 1 Surfactant. Heat the reactor contents to 130° C. and meter in 1475 grams of propylene oxide over 4 hours and then continue agitating at 130° C. for an additional 2 hours. Cool the reactor contents to 60° C.

Remove 158.2 grams of the reactor contents and neutralize with acetic acid to achieve a pH of 4-8 (in 10 percent aqueous solution) to obtain the WE 1 Surfactant.

Heat the reactor contents back to 130° C. and meter in 1170 g of propylene oxide into the reactor over 4 hours. Continue agitating at 130° C. for an additional 2 hours and then cool to 60° C. Remove 118.7 grams of reactor contents and neutralize with acetic acid in an 10 percent aqueous solution to a pH of 4-8 to obtain the WE 2 Surfactant.

Heat the reactor contents back to 130° C. and meter in 970 grams of propylene oxide over 4 hours and then continue to agitate for an additional 2 hours at 130° C. Cool the reactor contents to 60° C. Neutralize the contents of the reactor with acetic acid in a 10 percent aqueous solution to achieve a pH of 4-8 to obtain the WE 3 Surfactant.

Prepare surfactants for CE2 and WEs 4-7 in like manner adjusting the amount of PO and EO feeds to the appropriate mole ratios for those particular surfactants.

Testing of the surfactants of CE 1-4 and WE 0-7 was performed as detailed herein. The properties of each of the surfactants of CE1-4 and WE1-7 are included in Tables 1, 2, and 3. Each surfactant of WE 1-7 has the structure of structure (I) and the structure of each is given by specifying the values for m, n and z for each surfactant.

Cloud point was determined with a 1 or 10 weight-percent (wt %) solution of surfactant in deionized water (as indicated in Table 1) using a Mettler Toledo FP900 Thermal System with an FP90 central processor and FP81 measuring cell according to ASTM D2024-09.

Ross miles (a tendency of a surfactant to create and/or sustain foam) is measured according to the Ross-Miles test protocol ASTM designation D-1173-53 (0.1%, at 70° F.).

Pour point is measured using an automated MPP 5Gs instrument available from Instrumentation Scientifique de Laboratoire. The pour point measurements obtained with this instrument are correlated with ASTM D-97 “Standard Test Method for Pour Point of Petroleum Products”.

Surface tension of a surfactant is determined using a 0.1 wt % aqueous surfactant solution and a Kruss D12 tensiometer fitted with a Wilhelmy platinum plate at 25° C. Solutions are made by dissolving surfactant into deionized water. The deionized water used to make the solutions is 72-73 milliNewtons per meter. Results are reported as a mean of five repeated testing values with the standard deviation being less than 0.1 mN/m.

Solubility was determined for each surfactant by adding 3.6 g of an oil and 0.4 g of a surfactant (from WE 1-7 and CE 1-3) to a 20 mL borosilicate glass container. The glass container was then capped and hand-shaken for one minute. The mixture was analyzed after 1 day, 1 week and 2 months at room temperature and visually observed at each time interval for phase separation or haziness. After 2 months at room temperature, the samples were stored for 14 days at −5° C. and the samples were visually observed for phase separation. After the 14 days at −5° C., the samples were held for 14 days at room temperature and they were visually observed for phase separation or haziness. The solubility of a surfactant (Insoluble, Miscible) in Table 2 was determined based on visual observation after the 14 days at room temperature. In one embodiment, after mixing the oil and the surfactant, the active ingredients (pesticide) along with any optional components, e.g., softener, dispersant, and emulsifier, may then be added to the vessel under shearing conditions until the formation of a uniform agricultural composition including pesticide (oil dispersion) is achieved.

Foam height (FH) and emulsion stability (ES) were determined by combining 0.2 g of a solution of agricultural oil and a surfactant [90 wt % agricultural oil+10 wt % surfactant] in a 25 mL glass container. 19.8 g of water was added in the 25 mL glass container, and the container was sealed. The glass container was hand-shaken for 1 minute. The total volume of the emulsion was approximately 20 mL (which corresponds to approximately 4.2 centimeters (cm) height of solution from the bottom of the glass container). Pictures of the emulsions were taken at time 0 (after the minute of shaking) and taken again after 30 minutes at 25° C. The foam height (a distance of the foam extending orthogonally away from a liquid surface of the solution) was determined based on visual inspection and measurement after the minute of shaking. The emulsion stability was monitored for 30 minutes at 25° C. with a multiple light scattering Turbiscan device (Formulaction, France). Light transmission was used to analyze emulsion stability. The emulsion stability of a surfactant (emulsion, translucent) in Table 2 was determined initially at time (0) and at the end of the 30 minutes with the multiple light scattering Turbiscan device.

Biodegradability was determined for WE 1-7 according to Organization for economic co-operation and development (OECD) test method 301F.

TABLE 1

| | | | Ross Miles | | | Surf |
|---|---|---|---|---|---|---|
| | | Cloud | (mm) 0.1 wt % | | Pour | Tension |
| | | Point | | 5 | Point | (dynes/cm) |
| Example | Chemistry | (° C.) | Initial | min | (° C.) | 1.0 wt % |
| CE 1 | 2EH/5PO/9EO | 61 ^{a} | 60 | 0 | 16 | 31 |
| CE 2 | 2EH/5PO/14EO | 86 ^{a} | 70 | 10 | 6 | 32 |
| | (90% actives + 10% | | | | | |
| | water) | | | | | |
| CE 3 | TERGITOL XD | 74 ^{a} | 60 | 25 | 34 | 38 |
| CE 4 | DOWFAX 100N50 | >100 ^{a} | 80^{c} | 40^{c} | 45 | 39 |
| WE 1 | 2EH/5PO/9EO/5PO | 40.9 ^{b} | 20 | 0 | −18 | 34 |
| WE 2 | 2EH/5PO/9EO/10PO | 17.2 ^{b} | 0 | 0 | −15 | 34 |
| WE 3 | 2EH/5PO/9EO/15PO | 13.5 ^{b} | 0 | 0 | −18 | 35 |
| WE 4 | 2EH/5PO/14EO/10PO | 39.6 ^{b} | 30 | 0 | −3 | 34 |
| WE 5 | 2EH/5PO/14EO/15PO | 16.2 ^{b} | 0 | 0 | 3 | 35 |
| WE 6 | 2EH/5PO/14EO/20PO | 11.7 ^{b} | 0 | 0 | 3 | 35 |
| WE 7 | 2EH/5PO/14EO/25PO | 7.3 ^{b} | 0 | 0 | 3 | 35 |

^{a} 1.0 wt % in deionized (D.I.) water.
^{b} 10.0 wt % in D.I. water.
^{c}1.0 wt % in D.I. water

TABLE 2

| | | | | | Emulsion | Emulsion | |
|---|---|---|---|---|---|---|---|
| | | | Foam | Foam | stability | stability | Bio |
| | Solubility | Solubility | Height | Height | (Soybean oil) | (MSO) | degrad- |
| | (soybean oil) | (MSO) | (soybean oil) | (MSO) | Translucent/ | Translucent/ | ability |
| | Y/N | Y/N | (cm) | (cm) | emulsion | emulsion | (%) |
| CE 1 | N | Y | 1.4 | 0.6 | Translucent | Translucent | — |
| CE 2 | N | Y | 1.4 | 0.8 | Translucent | Emulsion | — |
| CE 3 | N | N | 0.6 | 0.5 | Translucent | Translucent | — |
| CE 4 | N | N | — | — | — | — | — |
| WE 1 | Y | Y | 0.7 | 0.6 | Translucent | Translucent | 85 |
| WE 2 | Y | Y | 0.6 | 0.3 | Translucent | Translucent | NM* |
| WE 3 | Y | Y | 0.3 | 0.2 | Emulsion | Emulsion | 90 |
| WE 4 | Y | Y | 0.7 | 0.7 | Translucent | Translucent | 80 |
| WE 5 | Y | Y | 0.4 | 0.4 | Translucent | Translucent | NM* |
| WE 6 | Y | Y | 0.2 | 0.2 | Emulsion | Translucent | 88 |
| WE 7 | Y | Y | 0.1 | 0.1 | Emulsion | Emulsion | NM* |

*NM mean not measured. However, for working examples (WE 2, WE 5, and WE 7) where only z is changing, the NM value for biodegradability is expected to fall between values for the analogous surfactants with higher and lower z values.

TABLE 3

| | | Δ | | Δ |
|---|---|---|---|---|
| | Initial | Transmission, | Initial | Transmission, |
| | Transmission, (%) | after 30 min (%), | Transmission, (%) | after 30 min (%), |
| | (Soybean oil) | (Soybean oil) | (MSO) | (MSO) |
| CE 1 | 1.0 | 5.5 | 0.1 | 0.1 |
| CE 2 | 9.0 | 15.0 | 0.1 | 0.1 |
| CE 3 | 1.4 | 2.5 | 1.8 | 1.7 |
| WE 1 | 0.2 | 2.2 | 0.3 | 1.0 |
| WE 2 | 0.5 | 2.2 | 0.3 | 1.1 |
| WE 3 | 0.1 | 0.4 | 0.1 | 0.9 |
| WE 4 | 1.0 | 3.6 | 1.2 | 3.5 |
| WE 5 | 0.5 | 2.8 | 0.7 | 1.3 |
| WE 6 | 0.1 | 1.0 | 0.4 | 1.0 |
| WE 7 | 0.1 | 0.5 | 0.1 | 0.1 |

Liquid surfactants: Each of the surfactants in WE 1-7 was a liquid at room temperature and ambient atmospheric pressure as evidenced by each of the surfactants of WE 1-7 having a pour point below room temperature (a pour point less than ˜23° C.). Specifically, as illustrated in Table 1 the surfactants of WE 1, WE2, WE 3, WE 4, WE 5, WE6, and WE7 had pour points of −18° C., −15° C., −18° C., −3° C., 3° C., 3° C., and 3° C. respectively. That is, each of the surfactants has a pour temperature that is at least 20 degrees less than room temperature ensuring that the surfactants of WE1-7 remain in a liquid state at room temperature. Having the surfactants in a liquid state can improve processability, improve oil solubility, etc., as compared to other surfactants such as those in a semi-solid state at room temperature.

Solubility, Foam Height, and Emulsion Stability:

CE 3 and CE4 demonstrate that butanol-POEO copolymers TERGITOL™ XD and DOWFAX™ 100N50, which are considered traditional POEO block copolymer are not compatible (not miscible with) with the agricultural oil. That is, as demonstrated in Table 2 both TERGITOL™ XD and DOWFAX™ 100N50 are insoluble in soybean oil and/or MSO. Similarly, CE 1 and CE 2 demonstrate that other PO/EO copolymers are insoluble in at least one of soybean oil and/or MSO. In contrast and surprisingly, each of the WE 1-7 is soluble in agricultural oils. That is, the surfactants of WE 1-7 are each soluble in both soybean oil and MSO, as illustrated in Table 2.

Further, WE 1-7 which are oil-soluble also have minimal foaming. For instance, each of WE 1-7 has less than 0.7 cm of foam in soybean oil and less than 0.6 cm of foam in MSO.

Further still, WE 1-7 which are oil-soluble also have an improved emulsion stability. For instance, WE 3, 6, and 7 exhibit stable white emulsions in soybean oil as compared to CE 1-3 which are translucent (do not form an emulsion in soy bean oil). As used herein, exhibiting emulsion stability described in Table 2 as an “emulsion” indicates a solution (e.g., WE 3 and WE 6-7 for soybean oil) had a Δ Transmission (after 30 minutes at 0.4 cm) of equal to or less than 1.0% (as detailed in Table 3), whereas the solutions (e.g., CE1-1 and WE 1-2, 4-5 for soybean oil) indicated as being “translucent” had a Δ Transmission of greater than 1.0 seconds (as indicated in Table 3).

Biodegradability: Each of the surfactants in WE 1-7 demonstrate a biodegradability value that is 80% or higher. A value of 60% is deemed “readily biodegradable” under the test method. Therefore, each of the surfactants of WE 1-7 is deemed readily biodegradable.

1. An agricultural composition comprising:
(a) an agricultural oil; and
(b) an agricultural oil-compatible, propylene oxide (PO)-capped liquid polymeric surfactant having the following structure: 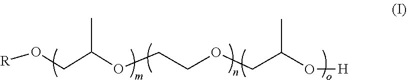
wherein m is an integer from about 3 to about 7, n is an integer from about 5 to about 20, and o is an integer from about 3 to about 30, and R is a linear or branched C4-C18 alkyl chain.

2. The agricultural composition of claim 1, wherein:
(a) is at least 60 percent, at least 70 percent or at least 80 percent by weight per volume of the agricultural composition; and
(b) is from about 0.5 to 40.0 percent, from about 1.0 to about 20.0 percent, from about 10.0 to about 20.0 percent, or from about 15.0 to about 20.0 percent by weight per volume of the agricultural composition.

3. The agricultural composition of claim 1, further comprising water, and wherein the agricultural composition exhibits lower foaming and improved emulsion stability as compared to agricultural compositions without (b).

4. The agricultural composition of claim 1, further comprising a pesticide.

5. The agricultural composition of claim 1, wherein m is an integer from about 3 to about 6 or an integer from about 3 to about 5.

6. The agricultural composition of claim 1, wherein m is about 5.

7. The agricultural composition of claim 1, wherein n is an integer from about 6 to about 15 or an integer from about 9 to about 14.

8. The agricultural composition of claim 1, wherein o is an integer from about 10 to about 25.

9. The agricultural composition of claim 1, wherein R is a branched C4-C18 alkyl chain.

10. An agricultural composition including pesticide comprising:
(a) an agricultural oil;
(b) an agricultural oil-compatible, propylene oxide (PO)-capped liquid polymeric surfactant having the following structure: 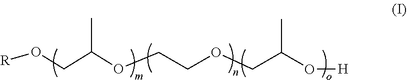
wherein m is an integer from about 3 to about 10, n is an integer from about 5 to about 20, and o is an integer from about 3 to about 30, and R is a branched C4-C18 alkyl chain; and
(c) a pesticide.
